(19) United States
(12) Patent Application Publication
(10) Pub. No.: US 2026/0218452 A1
(43) Pub. Date: Jul. 30, 2026

(54) METHOD AND APPARATUS FOR MANAGING PAPER-MAKING PROCESS USING DIGITAL TWIN

(71) Applicant: ELECTRONICS AND TELECOMMUNICATIONS RESEARCH INSTITUTE, Daejeon (KR)

(72) Inventors: JINYOUNG CHOI, Daejeon (KR); Sangkeum LEE, Daejeon (KR)

(21) Appl. No.: 19/446,519

(22) Filed: Jan. 12, 2026

(30) Foreign Application Priority Data
Jan. 24, 2025 (KR) 10-2025-0011452

(51) Int. Cl. D21G 9/00

(52) U.S. Cl. CPC D21G 9/0054

(57) ABSTRACT

A method and apparatus for managing a paper-making process using a digital twin are provided. The method includes generating a digital twin of the paper-making process synchronized with information of the paper-making process, which includes steam amount information of a dryer of the paper-making process and recovered heat amount information of a waste heat recovery system of the paper-making process, determining first settings of a digital twin of the dryer based on first paper-making information based on first paper-making information, estimating a first steam amount sequence by inputting the first settings and current steam amount information of the dryer to a steam amount estimation artificial intelligence (AI) model, and estimating a first recovered heat amount by inputting the first steam amount sequence and current recovered heat amount information of the waste heat recovery system to a recovered heat amount estimation AI model.

### CROSS-REFERENCE TO RELATED APPLICATION

This application claims the benefit of Korean Patent Application No. 10-2025-0011452, filed on Jan. 24, 2025, in the Korean Intellectual Property Office, the entire disclosure of which is incorporated herein by reference for all purposes.

### BACKGROUND

### 1. Field of the Invention

One or more embodiments relate to a method and apparatus for managing a paper-making process using a digital twin.

### 2. Description of the Related Art

A digital twin is technology that creates a replica of a real-world object on a computer and simulates potential real-world situations using a computer to predict results in advance. A digital twin is drawing attention as technology for solving issues across various industries and societies as well as in manufacturing.

A digital twin is fundamentally a combination of data and information representing the structure, context, and behavior of various physical systems. It serves as an interface for understanding past and present operational states and predicting the future. As a powerful digital object that can be used to optimize the physical world, a digital twin can improve operational performance and business processes.

### SUMMARY

A paper-making process in a paper manufacturing process may be a continuously active process. It may be difficult to determine an accurate amount of steam in a dryer for the paper-making process according to changes to settings of the dryer. Consequently, excessive thermal energy may be consumed to meet a steam quantity required for paper manufacturing.

According to an aspect, there is provided a method of managing a paper-making process including generating a digital twin of the paper-making process synchronized with information of the paper-making process, which includes steam amount information of a dryer of the paper-making process and recovered heat amount information of a waste heat recovery system of the paper-making process, determining first settings of a digital twin of the dryer based on first paper-making information including information of a type and a basis weight of first paper to be produced by the paper-making process, estimating a first steam amount sequence by inputting the first settings and current steam amount information of the dryer, which is synchronized with the digital twin of the dryer, to a steam amount estimation artificial intelligence (AI) model, and estimating a first recovered heat amount by inputting the first steam amount sequence and current recovered heat amount information of the waste heat recovery system, which is synchronized with a digital twin of the waste heat recovery system, to a recovered heat amount estimation AI model.

According to an aspect, there is provided an electronic device including one or more processors and a memory configured to store instructions executable by the one or more processors, wherein, when executed by the one or more processors, the instructions cause the electronic device to generate a digital twin of a paper-making process synchronized with information of the paper-making process, which includes steam amount information of a dryer of the paper-making process and recovered heat amount information of a waste heat recovery system of the paper-making process, determine first settings of a digital twin of the dryer based on first paper-making information including information of a type and a basis weight of first paper to be produced by the paper-making process, estimate a first steam amount sequence by inputting the first settings and current steam amount information of the dryer, which is synchronized with the digital twin of the dryer, to a steam amount estimation AI model, and estimate a first recovered heat amount by inputting the first steam amount sequence and current recovered heat amount information of the waste heat recovery system, which is synchronized with a digital twin of the waste heat recovery system, to a recovered heat amount estimation AI model.

Additional aspects of embodiments will be set forth in part in the description which follows and, in part, will be apparent from the description, or may be learned by practice of the disclosure.

According to embodiments, a steam amount and a recovered heat amount in a paper-making process according to changes to settings of a dryer may be estimated in real time using a digital twin for the paper-making process synchronized with an actual paper-making process. Based on the estimated steam amount and recovered heat amount, it may be determined whether the steam amount will be sufficient for paper manufacturing and whether excessive thermal energy will be wasted when the settings of the dryer change.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a block diagram schematically illustrating an interaction between a management device of a paper-making process and a user terminal, according to an embodiment;

FIG. 2 is a diagram illustrating an example of a process by which a managing device of a paper-making process estimates a recovered heat amount, according to an embodiment;

FIG. 3 is a flowchart illustrating an example of a process by which a management device of a paper-making process estimates a recovered heat amount, according to an embodiment;

FIG. 4 is a flowchart illustrating an example of a process by which a management device of a paper-making process determines settings of a digital twin of a dryer, according to an embodiment;

FIG. 5 is a diagram illustrating an estimation process of a steam amount estimation artificial intelligence (AI) model and a recovered heat amount estimation AI model, according to an embodiment;

FIG. 6 is a flowchart illustrating a method for a management device of a paper-making process to manage a paper-making process, according to an embodiment; and

FIG. 7 is a block diagram illustrating an example of a configuration of an electronic device that manages a paper-making process, according to an embodiment.

### DETAILED DESCRIPTION

The following detailed structural or functional description is provided as an example only and various alterations and modifications may be made to the embodiments. Thus, an actual form of implementation is not construed as limited to the embodiments described herein and should be understood to include all changes, equivalents, and replacements within the idea and the technical scope of the disclosure.

Although terms such as first, second, and the like are used to describe various components, the components are not limited to the terms. These terms should be used only to distinguish one component from another component. For example, a first component may be referred to as a second component, and similarly, the second component may also be referred to as the first component.

It should be noted that when one component is described as being “connected,” “coupled,” or “joined” to another component, the first component may be directly connected, coupled, or joined to the second component, or a third component may be between the first and second components.

The singular forms “a,” “an,” and “the” used herein are intended to include the plural forms as well, unless the context clearly indicates otherwise. It will be further understood that the terms “comprises/comprising” and/or “includes/including,” when used herein, specify the presence of stated features, integers, steps, operations, elements, and/or components, but do not preclude the presence or addition of one or more other features, integers, steps, operations, elements, components and/or groups thereof.

Unless otherwise defined, all terms used herein including technical and scientific terms have the same meanings as those commonly understood by one of ordinary skill in the art to which this disclosure pertains. Terms such as those defined in commonly used dictionaries are to be interpreted as having a meaning that is consistent with their meaning in the context of the relevant art and are not to be interpreted in an idealized or overly formal sense unless expressly so defined herein.

Hereinafter, the embodiments are described in detail with reference to the accompanying drawings. When describing the embodiments with reference to the accompanying drawings, like reference numerals refer to like components and a repeated description related thereto is omitted.

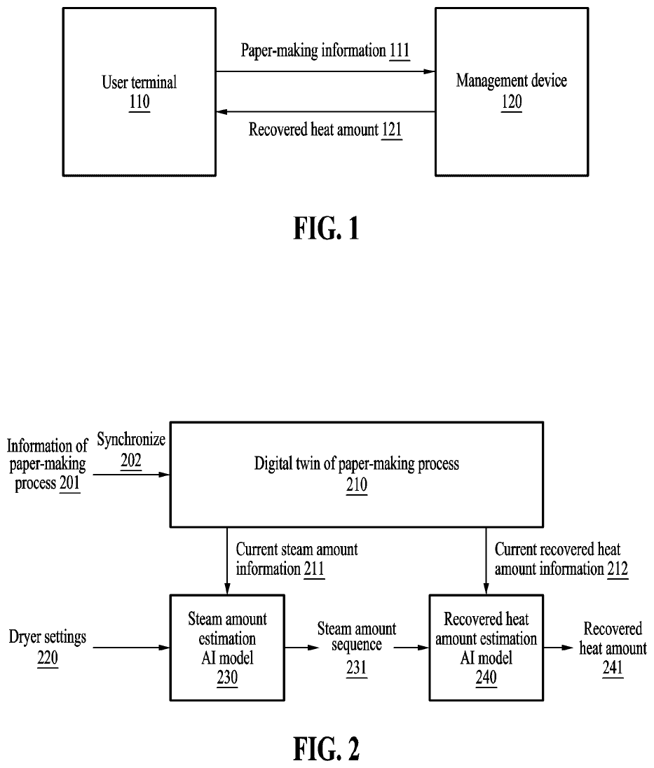

FIG. 1 is a block diagram schematically illustrating an interaction between a management device of a paper-making process and a user terminal, according to an embodiment. Referring to FIG. 1, a management device 120 of the paper-making process may receive paper-making information 111 from a user terminal 110. The paper-making process may be part of a paper manufacturing process. The paper-making process may be a process of chemically or mechanically processing and drying the raw material for paper, which may be a mixture of pulp and water, to form paper. The paper-making process may use a dryer that dries the raw material for paper. The raw material for paper may be produced during a composition process of the paper manufacturing process.

Drying of the raw material for paper in the paper-making process may require large amounts of heat energy. As the raw material of the paper being dried in the dryer changes, a steam amount required for a drying process may also change. It is a very difficult task to accurately implement the steam amount required for the drying process within the dryer of the paper-making process. Thus, in order to satisfy the steam amount required for the drying process, waste of heat energy may occur in the drying process of the paper-making process. The paper-making process may use a waste heat recovery system. The waste heat recovery system may be a system that recycles excess waste heat generated from a dryer used in the paper-making process. Less energy recovered by the waste heat recovery system may indicate less waste of heat energy generated in the paper-making process.

Since the paper manufacturing process is a continuously active process, it may be a difficult task to accurately calculate a time-series steam amount generated as setting values of equipment such as a dryer in the paper-making process change. Thus, a digital twin of the paper-making process may be used to estimate a time-series steam amount. The digital twin of the paper-making process is described in further detail with reference to FIG. 2 below. The user terminal 110 may be a terminal capable of monitoring a steam amount and a recovered heat amount in the paper-making process. The user terminal 110 may include a user interface.

Paper-making information 111 may be information including a type and basis weight of paper. The paper-making information 111 may be information regarding paper to be produced by the paper-making process. The paper-making information 111 may be information regarding paper to be produced through the paper-making process from the raw material for paper produced in the composition process. The information regarding the type of paper in the paper-making information 111 may be information regarding the type of paper to be produced by the paper-making process. For example, the information regarding the type of paper may correspond to white paper, corrugated paper, or white paperboard, but is not limited thereto. The information regarding the basis weight of the paper-making information 111 may be information regarding the weight per unit area of paper to be produced by the paper-making process. For example, the information regarding the basis weight may correspond to 100 g/m², 150 g/m², or 300 g/m², but is not limited thereto. Depending on the type and the basis weight of the paper, the steam amount required in the drying process of the paper-making process may vary. Thus, depending on the paper-making information 111, settings of the dryer of the paper-making process may need to be changed.

The management device 120 may estimate the steam amount of the paper-making process based on the paper-making information 111. The management device 120 may determine the settings of the dryer of the paper-making process based on the paper-making information 111. The management device 120 may estimate the steam amount of the paper-making process based on the settings of the dryer. The steam amount of the paper-making process may represent a steam amount of one dryer in the paper-making process. For example, when the paper-making process includes a pre-drying process and a post-drying process, the steam amount of the paper-making process may represent a steam amount of the dryer of the pre-drying process. The management device 120 may estimate a time-series steam amount of the paper-making process. The time-series steam amount of the paper-making process may be referred to as a steam amount sequence. The management device 120 may estimate a recovered heat amount 121 of the paper-making process based on the steam amount sequence. The recovered heat amount 121 of the paper-making process may represent a recovered heat amount of one waste heat recovery system of the paper-making process. For example, the recovered heat amount 121 of the paper-making process may represent a recovered heat amount of a waste heat recovery system corresponding to the pre-drying process of the paper-making process.

The management device 120 may provide the recovered heat amount 121 to the user terminal 110. The management device 120 may display the recovered heat amount 121 on the user interface of the user terminal 110. A greater recovered heat amount 121 estimated may indicate that more steam than necessary may be used in the dryer of the paper-making process. The management device 120 may help a user appropriately change the settings of the dryer of the paper-making process through the recovered heat amount 121 displayed on the user interface.

FIG. 2 is a diagram illustrating an example of a process by which a managing device of a paper-making process estimates a recovered heat amount, according to an embodiment. Referring to FIG. 2, the management device may generate a digital twin 210 of the paper-making process. The digital twin 210 of the paper-making process may represent a digital representation of equipment of an actual paper-making process. For example, the digital twin 210 of the paper-making process may represent the digital representation of the paper-making process, including digital representations of a dryer and a waste heat recovery system of the paper-making process. The management device may provide the digital representation of the digital twin 210 of the paper-making process to a user interface of a user terminal.

The management device may synchronize 202 information 201 of the paper-making process with the digital twin 210 of the paper-making process. The information 201 of the paper-making process may include steam amount information of the dryer of the paper-making process and recovered heat amount information of the waste heat recovery system of the paper-making process. The management device may receive the steam amount information of the dryer of the paper-making process from one or more sensors of the dryer of the paper-making process. The management device may receive the recovered heat amount information of the waste heat recovery system of the paper-making process from one or more sensors of the waste heat recovery system of the paper-making process.

The digital twin 210 of the paper-making process, which is synchronized 202 with the information 201 of the paper-making process, may represent real-time data of the paper-making process in a digital representation. For example, the digital twin 210 of the paper-making process may digitally represent current steam amount information 211 of the dryer and current recovered heat amount information 212 of the waste heat recovery system. The management device may provide a digital representation of real-time data of the digital twin 210 of the paper-making process to the user interface of the user terminal.

The management device may perform a simulation of the steam amount and the recovered heat amount of the paper-making process using information of the digital twin 210 of the paper-making process. For the simulation of the steam amount of the paper-making process, a steam amount estimation artificial intelligence (AI) model 230 may be used. The management device may input the current steam amount information 211 to the steam amount estimation AI model 230. The current steam amount information 211 may be steam amount information of the dryer of the paper making process synchronized with the digital twin of the dryer. The management device may input dryer settings 220 to the steam amount estimation AI model 230. The dryer settings 220 may be settings of a digital twin of the dryer, which may be part of settings of the digital twin 210 of the paper-making process. The steam amount estimation AI model 230 may be any AI model that uses a hidden state. For example, the steam amount estimation AI model 230 may be a recurrent neural network (RNN), a long short-term memory (LSTM), or a gated recurrent unit (GRU).

In an embodiment, the steam amount estimation AI model 230 may determine an initial hidden state value based on the current steam amount information 211. In an embodiment, the steam amount estimation AI model 230 may continuously receive the dryer settings 220 as input values. The dryer settings 220 may be changed at the time when the raw material for paper being dried in the dryer of the paper-making process is changed. The steam amount estimation AI model 230 may estimate a steam amount sequence 231 based on the current steam amount information 211 and the dryer settings 220. Each steam amount of the steam amount sequence 231 may be expressed in weight per hour or volume per hour, but embodiments are not limited thereto. For example, each steam amount of the steam amount sequence 231 may be expressed in kg/h. The steam amount sequence 231 estimated may correspond to a sequence of a steam amount of the dryer while the raw material for paper, corresponding to the paper to be dried in the dryer of the paper-making process, is dried in the dryer.

The steam amount estimation AI model 230 may be an AI model trained based on information of the digital twin 210 of the paper-making process. The information of the digital twin 210 of the paper-making process for training the steam amount estimation AI model 230 may be steam amount sequence information corresponding to dryer settings information and past dryer settings information of the digital twin 210. The management device may perform preprocessing on the steam amount sequence information of the digital twin 210 of the paper-making process. The preprocessing may include, for example, data classification, outlier handling (e.g., a local outlier factor algorithm), missing value handling (e.g., a K-nearest neighbors algorithm), noise handling (e.g., a discrete wavelet transform algorithm), and data standardization (e.g., a standardization algorithm). A loss for training the steam amount estimation AI model 230 may be determined based on the steam amount sequence information of the digital twin 210 and a steam amount sequence output by the steam amount estimation AI model 230.

For the simulation of the recovered heat amount of the paper-making process, a recovered heat amount estimation AI model 240 may be used. The management device may input the current recovered heat amount information 212 to the recovered heat amount estimation AI model 240. The current recovered heat amount information 212 may be the recovered heat amount information of the waste heat recovery system of the paper-making process, which may be synchronized with a digital twin of the waste heat recovery system. The management device may input the steam amount sequence 231 to the recovered heat amount estimation AI model 240. The recovered heat amount estimation AI model 240 may be any AI model that uses a hidden state. For example, the recovered heat amount estimation AI model 240 may be an RNN, an LSTM, or a GRU.

In an embodiment, the recovered heat amount estimation AI model 240 may determine an initial hidden state value based on the current recovered heat amount information 212. In an embodiment, the recovered heat amount estimation AI model 240 may receive the steam amount sequence as an input value. The recovered heat amount estimation AI model 240 may estimate a recovered heat amount sequence based on the current recovered heat amount information 212 and the steam amount sequence 231. Each recovered heat amount of the recovered heat amount sequence may be expressed in calories per hour, but embodiments are not limited thereto. A recovered heat amount 241 may correspond to a total sum of recovered heat amounts of the recovered heat sequence. The recovered heat amount 241 may be expressed in calories (e.g., kcal), but embodiments are not limited thereto. The recovered heat amount 241 may correspond to a total amount of recovered heat that may be recovered by the waste heat recovery system while the raw material for paper corresponding to the paper to be dried in the dryer of the paper-making process is dried in the dryer.

The recovered heat amount estimation AI model 240 may be an AI model trained based on the information of the digital twin 210 of the paper-making process. The information of the digital twin 210 of the paper-making process for training the recovered heat amount estimation AI model 240 may be recovered heat amount information corresponding to the steam amount sequence information and past steam amount sequence information of the digital twin 210. The management device may perform preprocessing on the recovered heat amount information of the digital twin 210 of the paper-making process. The preprocessing may include, for example, data classification, outlier handling, missing value handling, noise handling, and data standardization. A loss for training the recovered heat amount estimation AI model 240 may be determined based on the recovered heat amount information of the digital twin 210 and a recovered heat amount output by the recovered heat amount estimation AI model 240.

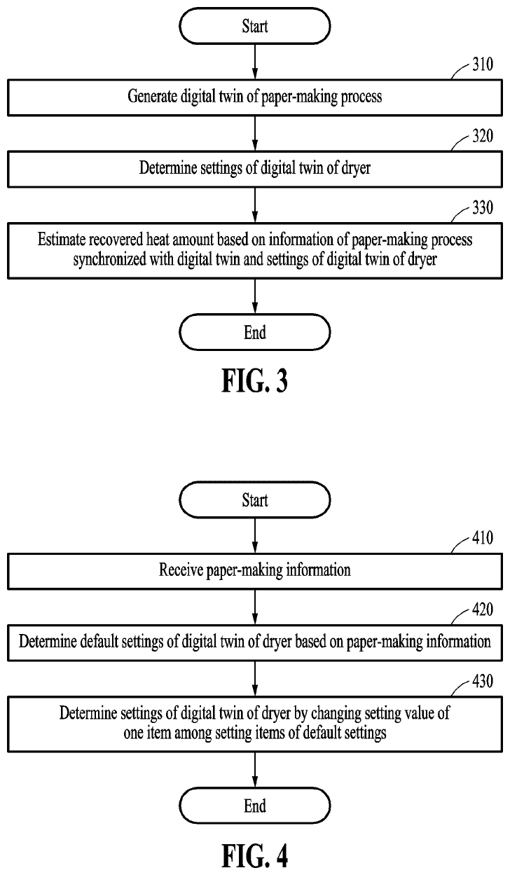

FIG. 3 is a flowchart illustrating an example of a process by which a management device of a paper-making process estimates a recovered heat amount, according to an embodiment. Referring to FIG. 3, in operation 310, the management device may generate a digital twin of the paper-making process. The digital twin of the paper-making process may correspond to the digital twin 210 of the paper-making process of FIG. 2. The management device may monitor a steam amount and the recovered heat amount of the paper-making process in real time through the digital twin of the paper-making process synchronized with actual equipment of the paper-making process.

In operation 320, the management device may determine settings of a digital twin of a dryer. The settings of the digital twin of the dryer may correspond to the dryer settings 220 of FIG. 2. The settings of the digital twin of the dryer may be determined based on information regarding the paper to be dried in the dryer of the paper-making process. The settings of the digital twin of the dryer may include, for example, setting values corresponding to production speed (e.g., wire speed, reel speed, etc.), steam pressure, and the like. A process of determining the settings of the digital twin of the dryer is described in further detail with reference to FIG. 4 below.

In operation 330, the management device may estimate the recovered heat amount based on information of the paper-making process synchronized with the digital twin and the settings of the digital twin of the dryer. The management device may estimate, using a steam amount estimation model, a steam amount sequence based on current settings of the dryer and a current steam amount of the paper-making process synchronized with the digital twin generated in operation 310. The management device may estimate, using the steam amount estimation model, a steam amount at a timepoint at which drying of a raw material for paper currently being dried may be completed. The management device may estimate, using the steam amount estimation model, a steam amount sequence of the raw material for paper to be dried in the dryer, based on the steam amount at the timepoint at which drying of the raw material for paper currently being dried may be completed and the settings of the digital twin of the dryer determined in operation 320. The management device may estimate, using the recovered heat amount estimation AI model, the recovered heat amount based on the steam amount sequence and a current recovered heat amount synchronized with the digital twin of the waste heat recovery system. The recovered heat amount estimated may correspond to the recovered heat amount 241 of FIG. 2.

The management device may calculate the recovered heat amount using physical equations without using an AI model. The management device may directly calculate the recovered heat amount based on the settings of the dryer and the information of the paper-making process synchronized with the digital twin of the paper-making process. In the process of calculating the recovered heat amount, Equations 1 to 3 below may be used. Equation 1 may be the Antoine equation, which is an empirical equation used to calculate vapor pressure of a liquid. Equation 2 may be a steam mass equation. Equation 3 may be a recovered heat equation.

$${T}_{steam} = a / ( b - log ( {P}_{steam} + {P}_{atm} ) ) - c \qquad [ Equation 1 ]$$

$${M}_{steam} = BW * A / ( 1 + W ) \qquad [ Equation 2 ]$$

$${Q}_{recovered} = η ( BW * \frac{A}{1 + W} ) * {H}_{steam} - {Q}_{loss} \qquad [ Equation 3 ]$$

Tₛₜₑₐₘ denotes steam temperature. a, b and C may be Antoine constants. Pₛₜₑₐₘ denotes steam pressure. Pₐₜₘ denotes atmospheric pressure. Mₛₜₑₐₘ denotes a mass of steam. BW denotes a basis weight of paper to be formed in the paper-making process. W denotes moisture content of paper to be formed in the paper-making process. A denotes an area of paper to be formed in the paper-making process. Q_{recovered} denotes a heat amount recovered in the waste heat recovery system. η denotes a thermal efficiency. Hₛₜₑₐₘ denotes enthalpy of vaporization of steam. Qₗₒₛₛ denotes a heat amount lost in the waste heat recovery system. η, Hₛₜₑₐₘ, and Qₗₒₛₛ may be set as optimization coefficients in Equation 3 and used in a linear regression model.

The management device may calculate a weighted sum of the recovered heat amounts based on the recovered heat amounts estimated using AI models, the recovered heat amounts calculated using predetermined physical equations, and the predetermined weights corresponding to each of the recovered heat amounts. When the recovered heat amount estimated using AI models and the recovered heat amount calculated using physical equations are a first recovered heat amount and a second recovered heat amount, respectively, the management device may calculate a third recovered heat amount based on the first recovered heat amount, the second recovered heat amount, and a predetermined weight. The management device may display the third recovered heat amount on the user interface of the user terminal. When using the recovered heat amount estimated using AI models and the recovered heat amount calculated using physical equations together, an error between the recovered heat amount displayed on a user interface and an actual recovered heat amount may be reduced compared to the case of estimating the recovered heat amount using only AI models.

The management device may display the estimated steam amount and recovered heat amount on the user interface of the user terminal. The user may determine whether the steam amount may be sufficient to produce paper and whether excessive heat energy may be wasted when the settings of the dryer are changed, based on the estimated steam amount and recovered heat amount.

FIG. 4 is a flowchart illustrating an example of a process by which a management device of a paper-making process determines settings of a digital twin of a dryer, according to an embodiment. Referring to FIG. 4, the management device may receive paper-making information in operation 410. The paper-making information may be information regarding a raw material for paper to be dried in a dryer of the paper-making process. The paper-making information may correspond to the paper-making information 111 of FIG. 1. Depending on the raw material for paper to be dried in the dryer of the paper-making process, settings of the dryer may need to be changed. By using AI models to display simulation results of a steam amount sequence and a recovered heat amount according to the settings of the digital twin of the dryer on a user interface, the management device may help a user determine appropriate settings of the dryer.

In operation 420, the management device may determine default settings of the digital twin of the dryer based on the paper-making information. The default settings may be settings appropriate for the paper intended to be produced by the paper-making process. In an embodiment, the default settings may be predetermined settings corresponding to the paper to be produced by the paper-making process. In an embodiment, the default settings may correspond to settings of the dryer most recently used in the dryer of the paper-making process, corresponding to the paper to be produced by the paper-making process.

In operation 430, the management device may determine the settings of the digital twin of the dryer by changing a setting value of one item among setting items of the default settings. The setting items of the default settings may include, for example, a production speed item, a moisture content item, and the like of the dryer of the paper-making process. A setting value of the moisture content item in the default settings may be, for example, 20%. The management device may determine first settings of the digital twin of the dryer by, for example, changing the setting value of the moisture content item among the setting items to 30%. The management device may determine one or more settings of the digital twin of the dryer. For example, the management device may determine second settings of the digital twin of the dryer by changing the setting value of the moisture content item among the setting items to 35%.

In an embodiment, although not shown in FIG. 4, when one setting of the one or more settings of the digital twin of the dryer has been determined by the user through the user terminal, operations 420 and 430 may be repeated using the selected setting as a default setting of operation 420.

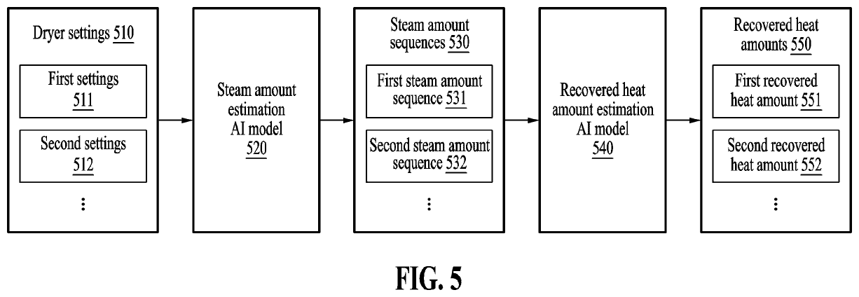

FIG. 5 is a diagram illustrating an estimation process of a steam amount estimation AI model and a recovered heat amount estimation AI model, according to an embodiment. Referring to FIG. 5, dryer settings 510 may include one or more settings. Each of the dryer settings 510 may be settings corresponding to paper to be produced in a paper-making process. The dryer settings 510 may include first settings 511 and second settings 512. Although two settings are shown in the dryer settings 510 of FIG. 5, the number of settings included in the dryer settings 510 is not limited thereto. The first settings 511 and the second settings 512 may correspond to the settings determined in operation 430 of FIG. 4.

In an embodiment, the first settings 511 and the second settings 512 may be settings determined by changing the one or more same setting value among the setting items of the digital twin of the dryer. For example, the management device of the paper-making process may determine the first settings 511 and the second settings 512 of the digital twin of the dryer by changing a setting value of a moisture content item, among setting items of default settings, from the default settings. In an embodiment, the first settings 511 and the second settings 512 may be settings determined by changing different setting values among the setting items of the digital twin of the dryer. For example, the management device of the paper-making process may determine the first settings 511 by changing a setting value of the moisture content item, among the setting items of the default settings, from the default settings, and may determine the second settings 512 by changing a setting value of the production speed item.

Paper-making information, on which each setting of the dryer settings 510 may be determined, may include a correlation coefficient of each item of the setting items of the digital twin of the dryer. The correlation coefficient of each item of the setting items may be any correlation coefficient between settings of a corresponding item and quality of a corresponding paper. The correlation coefficient may be, for example, the Pearson correlation coefficient. The quality of the paper may represent a variable to confirm a correlation between each item of the setting items of the digital twin of the dryer and the quality of the paper. The correlation coefficient of each item of the setting items may be a precalculated value.

Each setting of the dryer settings 510 may include information regarding the correlation coefficient of a setting item of which the value has been changed from the default settings. The management device of the paper-making process may classify each setting of the dryer settings 510 by comparing the correlation coefficient of the changed setting item of each setting of the dryer settings 510 with a predetermined value (e.g., a threshold value). For example, when the first settings 511 and the second settings 512 corresponding to a first paper are settings in which the setting value of the moisture content item and the setting value of the production speed item have been changed from the default settings, respectively, the correlation coefficients of the moisture content item and the production speed item corresponding to the first paper are 0.9 and 0.6, respectively, and the predetermined threshold value is 0.7, the management device of the paper-making process may classify the first settings 511 and the second settings 512 as a high correlation coefficient setting and a low correlation coefficient setting, respectively.

The management device may input each setting of the dryer settings 510 to a steam amount estimation AI model 520. For example, the management device may input the first settings 511 to the steam amount estimation AI model 520. For example, the management device may input the second settings 512 to the steam amount estimation AI model 520. The steam amount estimation AI model 520 may estimate a steam amount sequence based on each setting of the dryer settings 510. The steam amount estimation AI model 520 may estimate the steam amount sequence based on information of a digital twin of the paper-making process. For example, the steam amount estimation AI model 520 may estimate a first steam amount sequence 531 based on the first settings 511 and a current steam amount of the digital twin of the dryer. For example, the steam amount estimation AI model 520 may estimate a second steam amount sequence 532 based on the second settings 512 and the current steam amount of the digital twin of the dryer. Steam amount sequences 530 may include the first steam amount sequence 531 and the second steam amount sequence 532. The steam amount sequences 530 may include a steam amount sequence corresponding to each setting of the dryer settings 510. Each steam amount sequence of the steam amount sequences 530 may correspond to the steam amount sequence 231 of FIG. 2.

When the steam amount of the estimated steam amount sequence is not sufficient to produce paper, a simulation for the corresponding settings may not be necessary, without the need for an estimation of the recovered heat amount. When the steam amount included in each steam amount sequence of the steam amount sequences 530 is not sufficient to produce paper, a setting of the dryer corresponding to that steam amount sequence may be redetermined. For example, when at least one steam amount of the first steam amount sequence 531 is less than a predetermined steam amount corresponding to the first paper, the management device may redetermine the first settings 511 by rechanging a setting value of one item, among the setting items, from the default settings. The management device may estimate the steam amount sequence by inputting the redetermined settings to the steam amount estimation AI model 520. For example, the management device may estimate the first steam amount sequence 531 by inputting the redetermined first settings 511 to the steam amount estimation AI model 520.

The management device may display each steam amount sequence of the steam amount sequences 530 on the user interface of the user terminal. The management device may display each steam amount sequence and the dryer settings corresponding to each steam amount sequence on the user interface. The management device may classify the steam amount sequences 530 based on the correlation coefficient of the setting item, among the setting items of the dryer settings corresponding to each steam amount sequence of the steam amount sequences 530, of which a value has been changed, and may display the classified steam amount sequences 530 on the user interface of the user terminal. For example, the management device may classify and display on the user interface steam amount sequences corresponding to the high correlation coefficient setting and steam amount sequences corresponding to the low correlation coefficient setting.

The management device may display a performance evaluation index corresponding to a changed setting item corresponding to each steam amount sequence of the steam amount sequences 530 on the user interface. The performance evaluation index may be an index indicating how statistically similar an actual steam amount sequence and the steam amount sequence estimated by the steam amount estimation AI model 520 are when the corresponding setting item is changed. The performance evaluation index may be, for example, an R squared (R2) score, a mean squared error (MSE), a mean absolute error (MAE), a root mean squared error (RMSE), and the like, which may be precalculated based on the actual steam amount sequence and the steam amount sequence estimated by the steam amount estimation AI model 520. The performance evaluation index may be precalculated during a training process of the steam amount estimation AI model 520.

The management device may input each setting of the steam amount sequences 530 to a recovered heat amount estimation AI model 540. For example, the management device may input the first steam amount sequence 531 to the recovered heat amount estimation AI model 540. For example, the management device may input the second steam amount sequence 532 to the recovered heat amount estimation AI model 540. The recovered heat amount estimation AI model 540 may estimate the recovered heat amount based on each steam amount sequence of the steam amount sequences 530. The recovered heat amount estimation AI model 540 may estimate the recovered heat amount based on the information of the digital twin of the paper-making process. For example, the recovered heat amount estimation AI model 540 may estimate a first recovered heat amount 551 based on the first steam amount sequence 531 and the current recovered heat amount of the digital twin of the waste heat recovery system. For example, the recovered heat amount estimation AI model 540 may estimate a second recovered heat amount 552 based on the second steam amount sequence 532 and the current recovered heat amount of the digital twin of the waste heat recovery system. Recovered heat amounts 550 may include the first recovered heat amount 551 and the second recovered heat amount 552. The recovered heat amounts 550 may include a recovered heat amount corresponding to each steam amount sequence of the steam amount sequences 530. Each recovered heat amount of the recovered heat amounts 550 may correspond to the recovered heat amount 241 of FIG. 2.

The management device may display each recovered heat amount of the recovered heat amounts 550 on the user interface of the user terminal. For example, the management device may display the first recovered heat amount 551 and the second recovered heat amount 552 on the user interface. The management device may display each recovered heat amount and the dryer settings corresponding to each recovery heat amount on the user interface. The management device may display a minimum recovered heat amount, among the recovered heat amounts 550, and the dryer settings corresponding to the minimum recovered heat amount on the user interface. The management device may classify the recovered heat amounts 550, based on the correlation coefficient of the setting item, among the setting items of the dryer settings corresponding to each recovered heat amount of the recovered heat amounts 550, of which a value has been changed, and display the classified recovered heat amounts 550 on the user interface of the user terminal. For example, the management device may classify and display on the user interface recovered heat amounts corresponding to the high correlation coefficient setting and recovered heat amounts corresponding to the low correlation coefficient setting.

The management device may display a performance evaluation index corresponding to a changed setting item corresponding to each recovered heat amount of the recovered heat amounts 550 on the user interface. The performance evaluation index may be an index indicating how statistically similar an actual recovered heat amount and the recovered heat amount estimated by the recovered heat amount estimation AI model 540 are when the corresponding setting item is changed. The performance evaluation index may be, for example, an R2 score, an MSE, an MAE, an RMSE, and the like, which may be precalculated based on the actual recovered heat amount and the recovered heat amount estimated by the recovered heat amount estimation AI model 540. The performance evaluation index may be precalculated during a training process of the recovered heat amount estimation AI model 540.

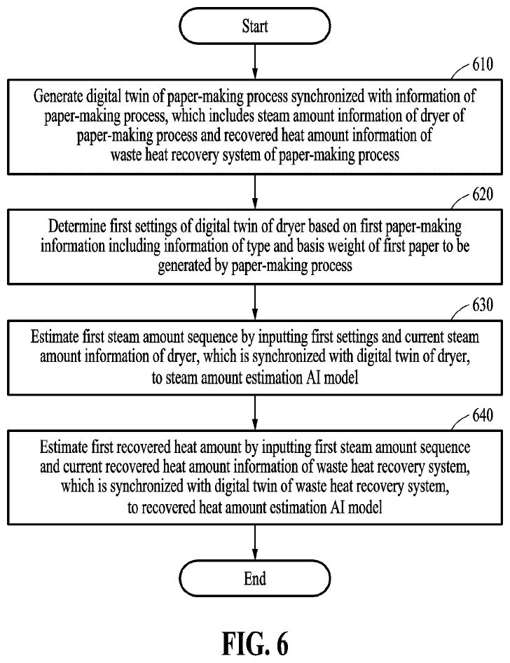

FIG. 6 is a flowchart illustrating a method for a management device of a paper-making process to manage a paper-making process, according to an embodiment. Referring to FIG. 6, in operation 610, the management device may generate a digital twin of the paper-making process synchronized with information of the paper-making process, which may include steam amount information of a dryer of the paper-making process and recovered heat amount information of a waste heat recovery system of the paper-making process.

In operation 620, the management device may determine first settings of a digital twin of the dryer based on first paper-making information including information of a type and a basis weight of first paper to be produced by the paper-making process. The management device may determine default settings of the digital twin of the dryer based on the first paper-making information. The management device may determine the first setting by changing a setting value of a first item, among setting items of the dryer, from the default settings. The default settings may correspond to settings of the dryer most recently used in the dryer of the paper-making process, corresponding to the first paper.

In operation 630, the management device may estimate a first steam amount sequence by inputting the first settings and current steam amount information of the dryer, which may be synchronized with the digital twin of the dryer, to a steam amount estimation AI model.

In operation 640, the management device may estimate a first recovered heat amount by inputting the first steam amount sequence and current recovered heat amount information of the waste heat recovery system, which may be synchronized with a digital twin of the waste heat recovery system, to a recovered heat amount estimation AI model. The first recovered heat amount may correspond to a total amount of recovered heat that may be recovered by the waste heat recovery system while raw material for paper corresponding to the first paper is dried in the dryer.

The management device may determine second settings of the digital twin of the dryer by changing the setting value of the first item from the default settings. The management device may estimate a second steam amount sequence by inputting the second settings and the current steam amount information to the steam amount estimation AI model. The management device may estimate a second recovered heat amount by inputting the second steam amount sequence and the current recovered heat amount information to the recovered heat amount estimation AI model. The management device may redetermine the first settings by rechanging the setting value of the first item from the default settings when at least one steam amount of the first steam amount sequence is less than a first predetermined steam amount corresponding to the first paper.

The management device may display the first settings and the first recovered heat amount on the user interface. The management device may display the first settings, the second settings, the first recovered heat amount, and the second recovered heat amount on the user interface. The management device may display a minimum recovered heat amount, among the first recovered heat amount and the second recovered heat amount, and the dryer settings corresponding to the minimum recovered heat amount on the user interface. The management device may calculate the second recovered heat amount by inputting the first paper-making information, the current steam amount information, and the current recovered heat amount information corresponding to the first paper to predetermined physical equations. The management device may calculate a third recovered heat amount based on the first recovered heat amount, the second recovered heat amount, and predetermined weights. The management device may display the first paper and the third recovered heat amount on the user interface.

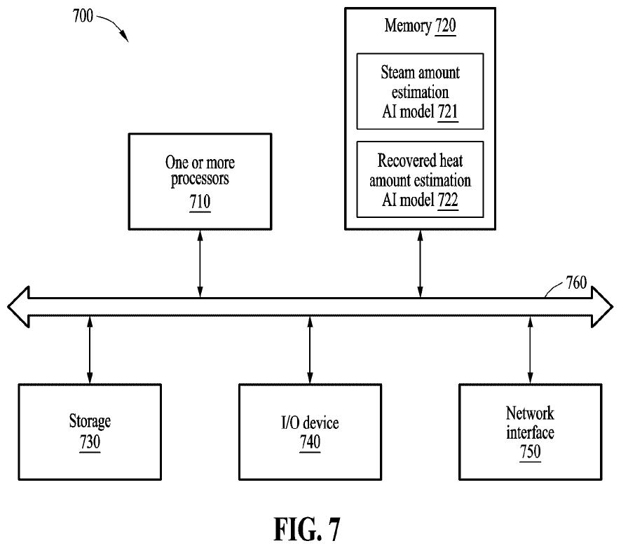

FIG. 7 is a block diagram illustrating an example of a configuration of an electronic device that manages a paper-making process, according to an embodiment. Referring to FIG. 7, an electronic device 700 may include one or more processors 710, a memory 720, a storage 730, an input/output (I/O) device 740, and a network interface 750. These components may communicate with each other via a communication bus 760. For example, the electronic device 700 may be implemented as at least a part of a mobile device such as a mobile phone, a smartphone, a personal digital assistant (PDA), a netbook, a tablet computer or a laptop computer, a wearable device such as a smart watch, a smart band or smart glasses, a computing device such as a desktop or a server, a home appliance such as a television, a smart television or a refrigerator, a security device such as a door lock, or a vehicle such as an autonomous vehicle or a smart vehicle.

The one or more processors 710 may execute instructions stored in the memory 720 or the storage 730. When executed by the one or more processors 710, the instructions may cause the electronic device 700 to perform the operations described with reference to FIGS. 1 to 6. The memory 720 may include a non-transitory computer-readable storage medium or a non-transitory computer-readable storage device. The memory 720 may store instructions to be executed by the one or more processors 710 and may store related information while software and/or an application is being executed by the electronic device 700. The memory 720 may store a steam amount estimation AI model 721 that performs a steam amount estimation in an embodiment. The memory 720 may store a recovered heat amount estimation AI model 722 that performs a recovered heat amount estimation in an embodiment. The operations described with reference to FIGS. 1 to 6 may be performed by the electronic device 700 in the state in which at least a portion of the steam amount estimation AI model 721 and/or the recovered heat amount estimation AI model 722 is stored in the memory 720.

The storage 730 may include a computer-readable storage medium or a computer-readable storage device. The storage 730 may store a greater amount of information than the memory 720 for a longtime. For example, the storage 730 may include a magnetic hard disk, an optical disc, a flash memory, a floppy disk, or other non-volatile memories known in the art.

The I/O device 740 may receive an input from the user in traditional input manners through a keyboard and a mouse, and in new input manners, such as a touch input, a voice input, and an image input. For example, the I/O device 740 may include a keyboard, a mouse, a touch screen, a microphone, or any other device that detects the input from the user and transmits the detected input to the electronic device 700. The I/O device 740 may provide an output of the electronic device 700 to the user through a visual, auditory, or haptic channel. The I/O device 740 may include, for example, a display, a touch screen, a speaker, a vibration generator, or any other device that provides the output to the user. The network interface 750 may communicate with an external device through a wired or wireless network.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The units described herein may be implemented using a hardware component, a software component and/or a combination thereof. For example, a processing device may be implemented using one or more general-purpose or special-purpose computers, such as, for example, a processor, a controller, an arithmetic logic unit (ALU), a DSP, a microcomputer, an FPGA, a programmable logic unit (PLU), a microprocessor, or any other device capable of responding to and executing instructions in a defined manner. The processing device may run an operating system (OS) and one or more software applications that run on the OS. The processing device may also access, store, manipulate, process, and create data in response to execution of the software. For purpose of simplicity, the processing device is described as singular. However, one of ordinary skill in the art will appreciate that a processing device may include multiple processing elements and/or multiple types of processing elements. For example, the processing device may include a plurality of processors, or a single processor and a single controller. In addition, a different processing configuration is possible, such as one including parallel processors.

The software may include a computer program, a piece of code, instructions, or one or more combinations thereof, to independently or collectively instruct or configure the processing device to operate as desired. Software and/or data may be embodied permanently or temporarily in any type of machine, component, physical or virtual equipment, computer storage medium or device, or in a propagated signal wave for the purpose of being interpreted by the processing device or providing instructions or data to the processing device. The software may also be distributed over network-coupled computer systems so that the software is stored and executed in a distributed fashion. The software and data may be stored in a non-transitory computer-readable recording medium.

The methods according to the embodiments may be recorded in non-transitory computer-readable media including program instructions to implement various operations of the embodiments. The media may also include the program instructions, data files, data structures, and the like alone or in combination. The program instructions recorded on the media may be those specially designed and constructed for the embodiments, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) discs and digital video discs (DVDs); magneto-optical media such as floptical disks; and hardware devices that are specially configured to store and perform program instructions, such as read-only memory (ROM), random-access memory (RAM), flash memory, and the like. Examples of program instructions include both machine code, such as those produced by a compiler, and files containing high-level code that may be executed by the computer using an interpreter.

The above-described hardware devices may be configured to act as one or more software modules in order to perform the operations of the above-described embodiments, or vice versa.

Although the embodiments have been described with reference to the limited number of drawings, one of ordinary skill in the art may apply various technical modifications and variations based thereon. For example, suitable results may be achieved if the described techniques are performed in a different order and/or if components in a described system, architecture, device, or circuit are combined in a different manner and/or replaced or substituted by other components or their equivalents.

Therefore, other implementations, other embodiments, and equivalents to the claims are also within the scope of the following claims.

What is claimed is:

1. A method of managing a paper-making process, the method comprising:
generating a digital twin of the paper-making process synchronized with information of the paper-making process, which comprises steam amount information of a dryer of the paper-making process and recovered heat amount information of a waste heat recovery system of the paper-making process;
determining first settings of a digital twin of the dryer based on first paper-making information comprising information of a type and a basis weight of first paper to be produced by the paper-making process;
estimating a first steam amount sequence by inputting the first settings and current steam amount information of the dryer, which is synchronized with the digital twin of the dryer, to a steam amount estimation artificial intelligence (AI) model; and
estimating a first recovered heat amount by inputting the first steam amount sequence and current recovered heat amount information of the waste heat recovery system, which is synchronized with a digital twin of the waste heat recovery system, to a recovered heat amount estimation AI model.

2. The method of claim 1, wherein
the first recovered heat amount corresponds to a total amount of recovered heat that is recovered by the waste heat recovery system while raw material for paper corresponding to the first paper is dried in the dryer.

3. The method of claim 1, wherein the determining of the first settings of the digital twin of the dryer comprises:
determining default settings of the digital twin of the dryer based on the first paper-making information; and
determining the first settings by changing a setting value of a first item, among setting items of the dryer, from the default settings.

4. The method of claim 3, further comprising:
determining second settings of the digital twin of the dryer by changing the setting value of the first item from the default settings;
estimating a second steam amount sequence by inputting the second settings and the current steam amount information to the steam amount estimation AI model; and
estimating a second recovered heat amount by inputting the second steam amount sequence and the current recovered heat amount information to the recovered heat amount estimation AI model.

5. The method of claim 3, wherein
the default settings correspond to settings of the dryer, which are most recently used in the dryer of the paper-making process, corresponding to the first paper.

6. The method of claim 3, further comprising:
redetermining the first settings by rechanging the setting value of the first item from the default settings when at least one steam amount of the first steam amount sequence is less than a first predetermined steam amount corresponding to the first paper.

7. The method of claim 1, further comprising:
displaying the first settings and the first recovered heat amount on a user interface.

8. The method of claim 4, further comprising:
displaying the first settings, the second settings, the first recovered heat amount, and the second recovered heat amount on a user interface.

9. The method of claim 8, further comprising:
displaying, on the user interface, a minimum recovered heat amount among the first recovered heat amount and the second recovered heat amount and settings of the dryer corresponding to the minimum recovered heat amount.

10. The method of claim 1, further comprising:
calculating a second recovered heat amount by inputting the first paper-making information, the current steam amount information, and the current recovered heat amount information corresponding to the first paper to predetermined physical equations;
calculating a third recovered heat amount based on the first recovered heat amount, the second recovered heat amount, and predetermined weights; and
displaying the first paper and the third recovered heat amount on a user interface.

11. A non-transitory computer-readable storage medium storing instructions that, when executed by a processor, cause the processor to perform the method of claim 1.

12. An electronic device comprising:
one or more processors; and
a memory configured to store instructions executable by the one or more processors,
wherein, when executed by the one or more processors, the instructions cause the electronic device to:
generate a digital twin of a paper-making process synchronized with information of the paper-making process, which comprises steam amount information of a dryer of the paper-making process and recovered heat amount information of a waste heat recovery system of the paper-making process;
determine first settings of a digital twin of the dryer based on first paper-making information comprising information of a type and a basis weight of first paper to be produced by the paper-making process;
estimate a first steam amount sequence by inputting the first settings and current steam amount information of the dryer, which is synchronized with the digital twin of the dryer, to a steam amount estimation artificial intelligence (AI) model; and
estimate a first recovered heat amount by inputting the first steam amount sequence and current recovered heat amount information of the waste heat recovery system, which is synchronized with a digital twin of the waste heat recovery system, to a recovered heat amount estimation AI model.

13. The electronic device of claim 12, wherein
the first recovered heat amount corresponds to a total amount of recovered heat that is recovered by the waste heat recovery system while raw material for paper corresponding to the first paper is dried in the dryer.

14. The electronic device of claim 12, wherein, when executed by the one or more processors, in order to determine the first settings of the digital twin of the dryer, the instructions cause the electronic device to:
determine default settings of the digital twin of the dryer based on the first paper-making information; and
determine the first settings by changing a setting value of a first item, among setting items of the dryer, from the default settings.

15. The electronic device of claim 14, wherein, when executed by the one or more processors, the instructions cause the electronic device to:
determine second settings of the digital twin of the dryer by changing the setting value of the first item from the default settings;
estimate a second steam amount sequence by inputting the second settings and the current steam amount information to the steam amount estimation AI model; and
estimate a second recovered heat amount by inputting the second steam amount sequence and the current recovered heat amount information to the recovered heat amount estimation AI model.

16. The electronic device of claim 14, wherein, when executed by the one or more processors, the instructions cause the electronic device to:
redetermine the first settings by rechanging the setting value of the first item from the default settings when at least one steam amount of the first steam amount sequence is less than a first predetermined steam amount corresponding to the first paper.

17. The electronic device of claim 12, wherein, when executed by the one or more processors, the instructions cause the electronic device to:
display the first settings and the first recovered heat amount on a user interface.

18. The electronic device of claim 15, wherein, when executed by the one or more processors, the instructions cause the electronic device to:
display the first settings, the second settings, the first recovered heat amount, and the second recovered heat amount on a user interface.

19. The electronic device of claim 18, wherein, when executed by the one or more processors, the instructions cause the electronic device to:
display, on the user interface, a minimum recovered heat amount among the first recovered heat amount and the second recovered heat amount and settings of the dryer corresponding to the minimum recovered heat amount.

20. The electronic device of claim 12, wherein, when executed by the one or more processors, the instructions cause the electronic device to:
calculate a second recovered heat amount by inputting the first paper-making information, the current steam amount information, and the current recovered heat amount information corresponding to the first paper to predetermined physical equations;
calculate a third recovered heat amount based on the first recovered heat amount, the second recovered heat amount, and predetermined weights; and
display the first paper and the third recovered heat amount on a user interface.
